(19) United States
(12) Patent Application Publication
(10) Pub. No.: US 2006/0276334 A1
(43) Pub. Date: Dec. 7, 2006

(54) Coated catalyst support body

(76) Inventors: Torsten Balduf, Marl (DE); Armin Lange De Oliveira, Hanau (DE); Werner Burkhardt, Brachttal (DE); Guido Stochniol, Haltern (DE)

Correspondence Address: SMITH MOORE LLP, P.O. BOX 21927, GREENSBORO, NC, 27420, US

(21) Appl. No.: 10/566,453

(22) PCT Filed: Jul. 30, 2004
(86) PCT No.: PCT/EP04/08590

§ 371 Date: Aug. 30, 2006

(30) Foreign Application Priority Data
Jul. 31, 2003 (DE) 103 35 510.3

(51) Int. Cl. B01J 21/04

(52) U.S. Cl. 502/439

(57) ABSTRACT

A catalyst support including a body having a surface and a coating bonded to the surface is disclosed. The coating includes fissures exhibiting a total fissure length of at least about 500 m/m² and an adhesive tensile strength of at least about 500 N/m². Using a catalyst support body to serve in the catalytic reaction of reactants, for example, in a partial oxidation of propene and acrolein to acrolein and acrylic acid, is disclosed. Also disclosed are processes for the: (a) production of a coating for a catalyst support body, (b) preparation of an organic molecule containing at least one double bond and oxygen, (c) production of a water-absorbing polymer, and (d) production of a water-absorbing hygiene article, and chemical products or the use of (meth)acrylic acid in chemical products.

This application is a national stage application under 35 U.S.C. 371 of international application No. PCT/EP2004/008590 filed Jul. 30, 2004, which is based on German Application No. DE 103 35 510.3 filed Jul. 31, 2003, and claims priority thereto.

The present invention relates to a catalyst support body having a surface on which a coating is provided. Such catalyst support bodies serve for the catalytic reaction of reactants, for example in the partial oxidation of propene and acrolein to form acrolein and acrylic acid, respectively. Also, embodiments of the present invention relate to a process for the production of a coating for a catalyst support body, a process for the preparation of an organic molecule containing at least one double bond and oxygen, a process for the production of a water-absorbing polymer, a process for the production of a water-absorbing hygiene article, and chemical products or to the use of (meth)acrylic acid in chemical products.

Reactors for carrying out catalyzed endothermic or exothermic reactions are known in various forms in the art. In catalyzed processes on a large industrial scale, the reactants are usually passed over flowable catalyst particles (loose material) that are arranged in a reaction chamber. The reactants are brought into contact with the catalyst that promotes a reaction. Because such reactions nevertheless frequently achieve high conversion rates only within a certain temperature range (even though it may be a relatively low temperature range), it is particularly important that those temperatures be maintained accurately over as long a period as possible, it being especially of concern in the case of chemical reactions that proceed exothermically that heat be dissipated sufficiently to avoid an uncontrolled progression of chemical reactions. Insufficient dissipation of heat in the case of exothermic reactions, as well as an insufficient supply of heat in the case of endothermic reactions, can result in a nonuniform temperature distribution within the reactor. Because it is very often the case in catalytic processes that different reactions take place at different temperatures, such a nonuniform temperature distribution can lead to a loss of selectivity and the associated formation of undesirable secondary products. A temperature distribution that is as uniform as possible, ideally an isothermal reaction procedure, is therefore desirable. In that way the reactions can be controlled exactly and the formation of secondary products suppressed. An increase in the efficiency of the reaction procedure in the region of only a few tenths of a percent is generally associated with considerable economic advantages for the large industrial processes for which the reactors are used.

In the case of the reactors described above, it is therefore known also to use cooled partitions made of metal plates that are arranged to form cavities, or interstices in the form of channels for holding and conducting a cooling medium for cooling purposes. The catalyst particles are arranged between two such partitions. It has been found in such reactors that the catalyst particles lying loose in the reaction chamber cannot be cooled sufficiently on account of the great distance from the cooling surface or the poor conduction of heat thereto. In that respect, a temperature gradient is often established in the reaction chamber in which certain sub-regions result in an undesirable nonuniform temperature distribution.

DE 101 08 380 describes a reactor for carrying out catalyzed chemical reactions having a heat exchanger that has reaction chambers and heat transport chambers separated from one another by dimpled plates. The catalyst is applied in the form of a thin layer to at least a portion of the surface of the dimpled plates that faces the reaction chamber. The reactor described therein, compared with conventional reactors equipped with individual catalyst particles, has a significantly smaller surface area for heat exchange that is able to initiate a catalytic reaction with the reactants in respect of the stream of gas passing over it. In addition, the reactor described in that specification has the disadvantage that the catalyst is applied to the inner side of the dimple plates. This is disadvantageous especially when the catalysts are used for the preparation of acrylic acid from propene, because the carbon deposits that inevitably form in that reaction are difficult to remove from the interior of the dimpled plates and, after prolonged operating periods, such deposits can clog the flow channels in the interior of the dimpled plate.

Embodiments of the present invention are directed to eliminating the technical problems known from the art.

An embodiment of the present invention is to provide a catalyst support body that ensures partial oxidation of propene and acrolein to acrolein and acrylic acid, with a high yield over a prolonged period.

Another embodiment of the present invention is to provide a process for the production of such a catalyst support body that is simple and economical to carry out and results in advantageous catalyst support body having a catalyst that, despite having a surface area that is as large as possible, exhibits good adhesion to a support body.

A further aim of the present invention is to provide a reactor which is distinguished by low maintenance work and a homogeneous temperature distribution.

Furthermore, an embodiment of the present invention provides for intensive contact between starting reaction materials and a catalyst to improve capacity and/or selectivity.

A further embodiment of the present invention is to provide an economical process, operating with a high conversion rate and high selectivity, for the preparation of organic molecules that contain at least about one double bond, from which it is possible to prepare, without an excessive amount of working-up, water-absorbing polymers that can in turn be incorporated into hygiene articles.

Another embodiment of the present invention is to provide both a catalyst support body and a process that allow gas phase oxidation of an olefin that takes place under conditions that proceed as closely as possible to the so-called explosion point occurring in corresponding gas phase oxidation.

It is also an embodiment of the present invention to provide an efficient catalyst system that, in comparison with conventional tube reactors charged with powder catalyst, has fewer reactor stoppages associated with changing the catalyst.

A catalyst support body according to an embodiment of the present invention has a surface and a coating bonded to the surface, the coating having fissures having a length, those lengths exhibiting a total fissure length of at least about 500 m/m² [meters per square meter] and the coating having an adhesive tensile strength of at least about 500 N/m² [Newtons per square meter].

In accordance with another embodiment of the present invention, a catalyst support body has a first thermal expansion coefficient, and the coating has a second thermal expansion coefficient. The two thermal expansion coefficients differ, at least at a temperature in the range of from about 20° C. to about 650° C., by at least about 10%. In one aspect, the difference is in the range of from about 15% to about 95%, in another aspect from about 15% to about 50%, in yet another aspect from about 15% to about 35%, and in even yet another aspect in the range of from about 15 to about 25%.

It should be pointed out that, in principle, it is immaterial which of the two components (catalyst support body and coating) has the lower expansion coefficient, but in one aspect, the coating exhibits the lower thermal expansion coefficient.

It should also be noted in this connection that a surface of the catalyst support body need not be totally covered by a coating, but it is advantageous for at least a portion of the surface bounding the reaction chamber, i.e., the outer surface (that is in contact with the environment), to be provided with such a coating. Although it is possible, in principle, for only spots, stripes, or similar sub-regions (for example at least about 50% in one aspect, or at least about 70% in another aspect) to be coated, an arrangement having a totally coated, outer surface is an aspect.

With respect to the thermal expansion coefficient, it should be emphasized that the term refers especially to a longitudinal expansion coefficient. The longitudinal expansion coefficient α is the quotient of relative change in length Δl/l₁ and the change in temperature ΔT, Δl being the change in length with respect to the initial length of the body prior to the temperature change (l₁) and the final length of the body after the temperature change (l₂), and ΔT being the temperature change (difference obtained from the temperature on measurement of the final length of the body and initial length of the body prior to the temperature change). This relationship is represented by the following formula:

$$α = \frac{Δ l}{{l}_{1} \cdot Δ T} ; \\ [ α ] = \frac{1}{K}$$

In order to take account of any irregularities in a material, etc., it is assumed in the present application that the thermal expansion coefficients given here are each an average value with respect to a catalyst support body or a coating. In order to take greater account of this, it is also possible, however, for the thermal expansion coefficient to be related not only to a change in length but possibly also to a change in surface area (two-dimensional consideration of the surface), or possibly even to a change in volume. Particularly with respect to a catalyst support body composed of a plurality of components, it should also be pointed out that its expansion coefficient relates especially to the components or building elements that form the surface on which the coating is provided.

It is stated that the two thermal expansion coefficients have a specified difference, at least at a temperature in the range of from about 20° C. to about 650° C. Such a difference can apply over the entire temperature range; the difference should apply at least to a temperature range of from about 200° C. to about 500° C. An expansion coefficient can be determined by measuring under a microscope, at a suitable temperature on a heated platform, the distance between points that are as far apart as possible on the corners and edges of the specimen body. In order to keep statistical variations to a minimum, about ten or more measurements have proved suitable.

It is desirable that an amount of difference is constant substantially over the entire temperature range (for example within a tolerance range of about 5% in one aspect, and in another aspect about 2%), but this is not absolutely essential.

When the temperature of the catalyst support body rises, the different thermal expansion coefficients have the effect that stresses arise in the coating or in the boundary layer between the catalyst support body and the coating. In one aspect, the catalyst support body has the higher thermal expansion coefficient; that is to say it has the greater tendency to expand in the event of an increase in temperature. This greater tendency in comparison with the coating has the result that tensile stresses are transmitted to the coating. It is to be assumed below that the adhesive forces, that is to say the adhesion of a coating to the surface of the catalyst support body, are sufficient to lastingly prevent the coating from flaking off from the catalyst support body in later use under ambient conditions. In that case, the tensile stress is transmitted to inner regions of the coating. For the case where the coating is, for example, in an unbroken surface, as has already been described with reference to the art, such tensile stress leads to the cohesive forces that are inside the coating being overcome, with the result that fissures, pores, or similar structures are formed in the interior or extending as far as the outer boundary layer of the coating. This may ultimately lead to a plurality of fissures being propagated through the coating, thus enlarging the outer surface of the coating that makes contact with, for example, reaction media flowing over it. Furthermore, as it were, “expansion joints” are formed which, by becoming wider, in turn compensate for the different thermal expansion behavior.

These effects have the result that such catalyst support bodies are especially efficient in respect of the reaction of the reaction media. The fissures created firstly contribute to a jagged, enlarged contact surface, but at the same time also ensure that the catalyst support body has a long service life under alternating thermal stress. As a consequence, relatively little maintenance work has to be carried out, and production can proceed continuously over a long period.

In accordance with an embodiment of the present invention concerning a catalyst support body, it is proposed that the coating has fissures having a length, the total fissure length being at least about 500 m/m² [meters per square meter]. In one aspect, the total fissure length is at least about 1000 m/m², in another aspect at least about 2000 m/m², and in yet another aspect at least about 4000 m/m². In an embodiment of the present invention, a maximum total fissure length can be in one aspect up to about 106 m/m², and in another aspect up to about 105 m/m².

“Fissures” can include those features in a coating that have in one aspect a length of at least about 200μ, and in another aspect at least about 500μ. It is assumed that such fissures involve an expansion of a material in a preferred direction of extension; that is to say that it does not extend equally in all directions (or is anisotropic). The width of such fissures is usually at most about 1/10 of the length of the fissure. The depth of a fissure, that is to say the extension in the direction of the thickness of the coating, depends substantially upon the thickness of the coating itself. It should be assumed here that a fissure is referred to when its depth is at least about 80% in one aspect, and in another aspect at least about 90%, of the layer thickness. By grinding the catalyst layers, deeper layers are exposed, and the fissure depth can be reproduced iteratively.

Usually such a coating will not have a continuous fissure, but will instead have fissures that are distributed in some way and are each of different length. The “total fissure length” mentioned herein, that is to say the sum of all (individual) lengths of the fissures, relates to a unit surface area of about 1 m×1 m. To determine the total fissure length, it is proposed that the coating in a working surface (of any dimensions) be viewed, for example, under a microscope. Images of such working surfaces can be measured and read out, for example, using image-processing software. The individual lengths of the fissures can be determined and added up automatically or manually, so that an absolute total fissure length is obtained. This absolute total fissure length is then related to a unit surface area of about 1 m×1 m in order to determine the relative total fissure length, mentioned herein. It will be clear that this is again a statistical average, so that in respect of a coating, a plurality of small working surfaces may be measured and read out in order finally to obtain a more exact (absolute or relative) total fissure length. The total fissure length per unit surface area given herein provides a kind of specific fissure frequency. This characterizes the extent to which the surface of the coating is enlarged during use, i.e., to what extent thermal stresses can be compensated by the fissures. The latter is advantageous particularly with a view to coatings which are not intended to form further fissures during use as a result of the different thermal expansion coefficients but in which the fissures are to be produced only during manufacture—during normal operation, the cohesive forces that are in the coating are accordingly not exceeded.

In accordance with another embodiment of the present invention concerning a catalyst support body, a coating has a layer thickness of at least about 0.02 mm [millimeters]. In one aspect, the layer thickness can be in a range of from about 0.1 mm to about 3 mm, in another aspect in a range of from about 0.5 mm to about 2 mm, and in yet another aspect in a range of from about 0.7 mm to about 1.2 mm. The layer thicknesses mentioned herein are relatively thick also with respect to the materials of the catalyst support body used, but they are beneficial, for example, for the provision of a sufficient catalytic surface in the case of partial oxidation of propene and acrolein to acrylic acid.

In that respect, the combination of the above-mentioned (relative) total fissure length per unit cross-sectional surface area and the especially large layer thicknesses also has a surprising effect. Here, the function of compensating the differing thermal expansion behavior comes into increased effect. Accordingly, it is precisely in the case of large layer thicknesses that there is a high total fissure length. It should be added here, by way of explanation, that the layer thickness again relates to a value that is averaged over the entire coating. It relates to the spacing of the surface of the catalyst support body from the opposing boundary layer of the coating.

It is also proposed that in one aspect the coating have an adhesive tensile strength of at least about 500 N/m² [Newtons per square meter], and in another aspect at least about 10,000 N/m². In one aspect, the adhesive tensile strength can be in a range of from about 500 N/m² to about 100,000 N/m², and in another aspect in a range of from about 1000 N/m² to about 25,000 N/m². In general, the adhesive tensile strength is limited at the upper end by the stability of the catalyst.

The adhesive tensile strength serves as a measure of the adhesive forces, that is to say the surface adhesion of the coating to the catalyst support body. The adhesive tensile strength can be greater than the cohesive forces that are obtained in the interior of the coating.

For determining the adhesive tensile strength, the following method, for example, is suitable: a die of predetermined dimensions is placed on a coating applied to a catalyst support body and joined thereto. The joint can be made by mechanical anchoring, adhesive bonding, or in a similar manner. The die is then connected to a removal device that indicates the tensile force acting on the coating. The tensile force is then increased, stepwise or continuously, until substantial portions of the coating are torn free of the surface of the catalyst support body. The value so obtained represents the adhesive tensile strength in the present context.

The adhesive tensile strength can be determined as follows: a cuboidal die having a base surface area A of about 1 cm² is fixed to the catalyst layer by means of a double-sided adhesive element of the same surface area A. By means of a spring balance, the force absorption under tension perpendicular to the layer is monitored. The maximum applied force F immediately before detachment of the catalyst layer from the support plate, less the weight G exerted by the die, gives the adhesive tensile strength (HZF) with HZF=(F−G)/A. If the adhesive element on the catalyst layer has a lower adhesive tensile strength than the layer on the support plate, only a lower boundary value can be indicated. Generally, however, the adhesive tensile strength of the catalyst layer in such a case is sufficient.

In accordance with a further embodiment of the present invention concerning a catalyst support body, the coating is a catalytically active coating for partial oxidation of propene to acrolein and further to acrylic acid. In an aspect, a catalytically active coating is a metal or salt of a metal, here a metal oxide. In one aspect, metals comprise transition metals and lanthanoids. In another aspect, metals comprise the metals of sub-groups 5 and 6, with Mo, V, Nb, and W being yet another aspect and Mo, W, and V being still yet another aspect. In another embodiment of the present invention concerning a suitable catalyst, the catalyst contains Ni in addition to one or more of the above metals. In connection with suitable catalysts and conventional reactors, reaction conditions and purification methods for the preparation of acrolein and acrylic acid, reference is made to “Stets Geforscht,” Vol. 2, Chemieforschung im Degussa-Forschungszentrum Wolfgang 1988, pages 108-126, chapter “Acrolein und Derivate,” Dietrich Arntz and Ewald Noll. The metals can be in oxide form, in pure form, or in the form of mixtures, alloys, or intermetallic phases.

It is also proposed that the coating comprise, in addition to the catalyst, at least one inert and therefore non-catalytically acting constituent. The latter can be in X-ray-amorphous form, with special preference being given to oxide's of aluminum and oxides of silicon.

In an embodiment of the present invention, an organic auxiliary can be used in a coating and, in an aspect, can be water-soluble. An organic auxiliary can be incorporated into the coating prior to drying. This can be effected by bringing the auxiliaries into contact with the other constituents prior to a coating of a surface. For example, a slurry having the other constituents of the coating can be made as coating suspension with those auxiliaries by mixing and homogenization. Polymeric substances can be organic auxiliaries. In one aspect, molecular weights (Mₙ) of more than about 5000 g/mol, in another aspect more than about 20,000 g/mol, and in yet another aspect more than about 100,000 g/mol, have proven suitable. In turn, polysaccharides or derivatives thereof can be polymers. Polysaccharides include the branched polysaccharides, especially cellulose and derivatives thereof. Derivatives that come into consideration include especially oxygen derivatives, such as ethers. Of those, cellulose ethers, such as Tylose®, are an aspect.

In accordance with a further embodiment of the present invention concerning a catalyst support body, a coating comprises at least about one silicon-containing and oxygen-containing constituent. The silicon-containing and oxygen-containing constituent can be an AEROSIL® (Degussa AG, Germany).

In respect to a catalyst support body, it is also proposed that it be constructed using metallic material. The metallic material can comprise at least one of the following elements: aluminum, iron, and/or nickel. In principle, it should first be ascertained that the metallic material has particularly good properties in respect of heat conduction; that is to say that rapid dissipation of heat or rapid supply of heat to the catalyst or the catalytically active coating is possible. In addition, the metallic material has the advantage that it has a high degree of shapeability. That means that application-specific parameters (for example the spatial conditions in any particular case) can easily be taken into account in the preparation of the catalyst support body, and a certain degree of customization for installation in a reactor is also possible. As a result of the conditions in the reaction chamber, it is advantageous for the catalyst support body to be resistant to high temperatures and corrosion. In that connection, it is advantageously proposed that the metallic material have a sufficient content of aluminum, iron, and/or nickel. For example, the following steels, nickel alloys, and titanium alloys are among aspects: steel 1.4571 (V2A) having a α (about 20° C. to about 400° C.) of about 18.5×10⁻⁶/K; steel 1.4401 having an α (about 20° C. to about 400° C.) of about 18.5×10⁻⁶/K; steel 1.4903 having an α (about 20° C. to about 400° C.) of about 14×10⁻⁶/K; steel 1.4713 having an α (about 20° C. to about 400° C.) of about 12×10⁻⁶/K; Ni alloy 2.4617 having an α (about 20° C. to about 400° C.) of about 11.4×10⁻⁶/K; Ni alloy 2.4816 (Iconel® 600) having an α (about 20° C. to about 400° C.) of about 14.5×10⁻⁶/K; and Ti alloys 3.7025 and 3.7035 having an α (about 20° C. to about 400° C.) of about 9.3×10⁻⁶/K.

Particularly in this context, it is advantageous that a catalyst support body comprises a multi-walled sheet structure with at least one channel through which a substance is able to flow. In other words, such a multi-walled sheet structure is not only a simple heat exchange wall, but rather it is suitable, for example, for conveying the coolant in its interior. That means that the entire surface that bounds the sheet structure toward the outside to the environment can be used for coating, and accordingly, also for promoting the chemical reactions that take place there.

“Multi-walled” can be understood as meaning, for example, a combination of two parallel sheets that have in the interior individual ribs, sleeves, guide surfaces, tubes, etc., which on the one hand keep the two sheets spaced apart, and on the other hand also divide the interior into flow channels or flow chambers. Such sheet structures are usually equipped with an inflow and an outflow, so that a coolant or heating medium can pass through. The coolant or heating medium, which is referred to herein generally as “substance,” is usually gaseous or liquid. It is also possible, however, for such a substance to have gas and/or liquid components; the gaseous and/or liquid substances can also carry solids.

A channel itself can allow free passage of substances; that is to say that no additional materials are integrated therein. Because the same flow resistance should apply as far as possible over the entire cross-section of the sheet structure, in order to facilitate uniform dissipation of heat and a uniform supply of heat over the surface of the sheet structure, the use of additional materials or components in the interior of the channel can be usually disadvantageous.

In accordance with an embodiment of the present invention, a catalyst support body can comprise a plurality of plates that form openings through which a fluid is able to flow. The term “openings” means especially passageways that can be seen in a cross-section through such a plate structure. Whereas, above, a sheet structure forms channels in which a partial flow of substance is conducted through the sheet structure independently of a further partial flow of substance, this need not necessarily be the case with the variant proposed here that comprises a plurality of plates having openings through which substance is able to flow. Rather, a plurality of cavities that communicate with one another (that is to say exchange flow with one another) can be provided between the plates.

The plates can form substantially planar sheets that may be provided with a texture. Such a texture can be of a height that is small in comparison to the length or width of the sheet, especially less than about 10%. Such texturing of the plates can result in an enlargement of the surface area of a catalyst support body so that, at the same time, more coating material can be applied. Examples of textures that have proved suitable are ribs, corrugations, lumps, or the like.

Such a catalyst support body can be in the form of a so-called “dimpled plate.” A “dimpled plate” comprises metal plates that are welded together, forming connecting regions at predetermined points or along predetermined lines, or are joined together by some other joint-forming technique, with flow channels being formed between the connecting regions. This can be generally carried out, once the joints have been formed by joint-forming techniques, by subjecting the space between the metal plates to a pressure that results in a plastic deformation of the regions of the metal sheets not joined to one another. There are thus formed cushion-like bulging portions that usually produce elliptical flow opening cross-sections. Such a “dimpled plate” can be self-supporting and allow the provision of a compact heat exchanger having a large heating surface area.

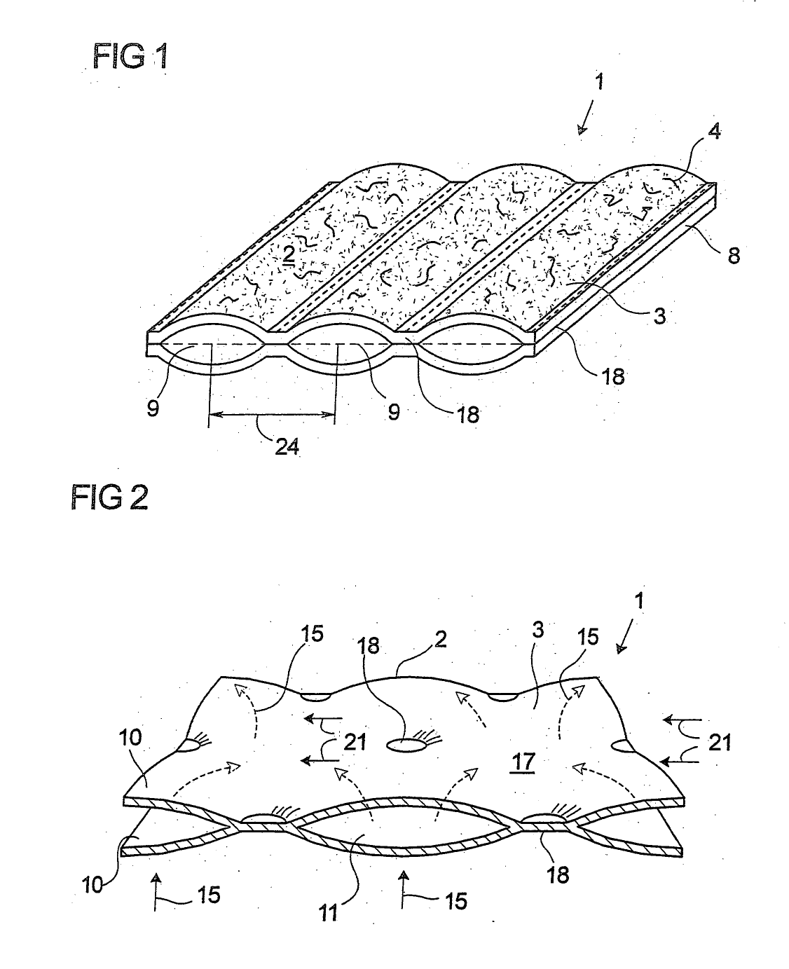

When “dimpled plates” are used as catalyst support bodies, in an embodiment concerning a catalyst support body according to the present invention in which a coating has fissures having a total fissure length of at least about 500 m/m², the coating is applied not to the inner side of the cushion-like bulging portions, but to the outer side of those bulging portions (variant A). The “outer side” of a dimpled plate is to be understood as being that side of the dimple plate that has been given reference numeral 2 in FIG. 1. In variant A, a coolant flows through the flow channels that are formed in the interior of the “dimpled plate” by the welding together of metal plates at predetermined points or along predetermined lines. In another embodiment of the catalyst support body according to the present invention, when “dimpled plates” are used, the coating is applied to a surface of the above-mentioned flow channels so that, in this case, the coolant flows through the interstices of two adjacent “dimpled plates” and accordingly along the outer surface of the cushion-like bulging portions of the “dimpled plates” (variant B).

When “dimpled plates” are used as catalyst support bodies, variant A is a further aspect according to the present invention.

In accordance with an embodiment of the present invention, a catalyst support body is constructed using ceramic material. The ceramic material used for this purpose can be one that comprises at least one of the following: codierite, silicon carbide, aluminum oxide, silicon oxide, and/or titanium oxide. A catalyst support body of ceramic material can be an alternative, for example, when relatively small catalyst support bodies are required, or when catalyst support bodies can be simply produced in an extruding process. In addition, such ceramic catalyst support bodies offer the possibility of exploiting their inherent property of porosity and using a material of a catalyst support body for increasing the adhesive strength in respect of a coating or the effectiveness of the catalytically active coating. In principle, customized catalyst support bodies that comprise both metallic and ceramic material are also possible.

A further embodiment of the present invention comprises a catalyst support body having a surface on which a coating bonded to the surface is provided, the catalyst support body being a dimple plate and the coating being applied to the outer side of the dimple plate, the “outer side” of a dimple plate again being understood as the side of the dimple plate given reference numeral 2 in FIG. 1. Coatings can be those already mentioned above as being as aspect, and here too, special preference is given to a catalytically active coating for the partial oxidation of propene and acrolein. A layer thickness of the coating and its adhesive tensile strength also can correspond to the layer thicknesses and adhesive tensile strengths already mentioned above in connection with the coating of the catalyst support body.

In an aspect of an embodiment concerning a catalyst support body described above, which comprises a dimple plate provided on the outside with a coating, the coating has fissures with a total fissure length of at most about 500 m/m² [meters per square meter], in another aspect at most about 250 m/m², in yet another aspect at most about 100 m/m², in even yet another aspect at most about 10 m/m², and in even yet a further aspect at most about 1 m/m², a coating without fissures being still yet another aspect. A determination of the total fissure length can be effected in the way described at the beginning.

In accordance with a further embodiment of the present invention, there is proposed a reactor for the preparation of polymerizable monomers having at least one reaction chamber through which a fluid is able to flow, the at least one reaction chamber comprising at least about one catalyst support body, as described above. The reaction chamber can be a column, a reservoir, or some other, in an aspect sealable, space that can withstand pressures in the range of from about 1 bar to 50 bar in one aspect, in another aspect in the range of from about 2 bar to about 40 bar, and in yet another aspect in the range of from about 10 bar to about 35 bar. Such reaction chambers can have a plurality of catalyst support bodies that are especially arranged parallel to one another and accordingly define sub-volumes through which the reaction mixture is conducted. A reaction chamber for a preparation of polymerizable monomers, such as acrolein or acrylic acid, usually has at least about two catalyst support bodies that are arranged next to one another. In one aspect, the individual catalyst support bodies are spaced substantially equal distances apart from one another. It is thus ensured that the dissipation and supply of heat is uniform over the entire reaction chamber, and accordingly, a homogeneous temperature distribution is obtained.

In accordance with a further embodiment of the present invention, a process for a production of a coating on a surface of a catalyst support body is proposed that comprises at least the following steps:
preparing a solid/fluid phase with a catalyst suitable for the preparation of an organic molecule containing at least about one double bond and oxygen;
applying the solid/fluid phase to a catalyst support body, and/or
forming a coating having fissures having a total fissure length of at least about 500 m/m² [meters per square meter].

In one aspect, a total fissure length per unit cross-sectional surface area can be at least about 1000 m/m², in another aspect about 2000 m/m², and in yet another aspect at least about 4000 m/m².

In accordance with a further embodiment of the present invention, a process for the production of a coating on a dimple plate as a catalyst support body is proposed that comprises at least the following steps:
preparing a solid/fluid phase with a catalyst suitable for the preparation of an organic molecule containing at least about one double bond and oxygen,
applying the solid/fluid phase to the outer side of the dimple plate, and/or
forming a coating on the outer side of the dimple plate.

In one aspect, the total fissure length in the coating per unit cross-sectional surface area is at most about 500 m/m², in another aspect at most about 250 m/m², in yet another aspect at most about 100 m/m², in even yet another aspect at most about 10 m/m², and in even yet a further aspect at most about 1 m/m², or there are substantially no fissures.

A solid/fluid phase can be a slurry containing at least a catalyst and optionally also at least about one of the above-described additives. It is in turn an aspect that it contains about one or more catalyst precursors from which the crude catalyst powder is obtained, or at least about one crude catalyst powder, or at least about one catalyst precursor and at least about one crude catalyst powder, as such or in the form of a slurry, in an amount in the range of from about 10% to about 90% by weight in one aspect, in another aspect from about 30% to about 80% by weight, and in yet another aspect from about 40% to about 70% by weight, in each case based on the solid/fluid phase. Any fluid phase known to a person skilled in the art as being suitable may be considered. Aspects include water, or alcohols such as ethanol, acetone, or hexane, or mixtures of at least about two thereof, with water or alcohols being one aspect and water being another aspect.

In accordance with the second process step, a solid/fluid phase is applied to a catalyst support body. Application can comprise spray-application, vapor deposition, spreading, appliqué, adhesive bonding, sintering, or similar production methods. A catalyst can also be applied by the use of at least about one of the following methods: CVD, PVD, sputtering, reactive sputtering, galvanic methods, or the like. It is also possible in principle for a plurality of the above-mentioned production methods to be used in combination with one another. It is also possible for the production methods to be carried out a number of times repeatedly or alternately. In some cases, it may also be advisable to carry out the application discontinuously, observing rest periods or carrying out a thermal treatment between the individual application processes.

Finally, a coating is generated that has fissures of the above-mentioned fissure frequency, i.e., of the mentioned total fissure length. In an aspect where a coating still does not have a desired total fissure length after the second process step has been carried out once, it is proposed that the second step be repeated until the total fissure length indicated herein is achieved. Of particular assistance in this regard are combinations of thermal treatments of the catalyst support body or mechanical deformations of the catalyst support body having the coating, as explained in greater detail below.

In accordance with a further embodiment of a process according to the present invention, prior to an application of the solid/fluid phase, a catalyst support body can be subjected to an adhesion-enhancing treatment. As already mentioned at the beginning, it is advantageous for the surface adhesion between a catalyst support body and a coating to be relatively high and long-lasting. It is, therefore, likewise advantageous for a surface of a catalyst support body to be so treated prior to the application of the solid/fluid phase that the formation of thermally and dynamically highly stressable bonds between a catalyst support body and a coating is promoted.

In this connection, it is proposed as an embodiment of the present invention that as “adhesion-enhancing” step (especially in respect of catalyst support bodies of metallic material), at least one of the following steps is carried out:
a) abrasive blasting of the surface,
b) machining of the surface,
c) cleaning of the surface, and/or
d) thermally treating of the surface.

“Abrasive blasting” can be understood in the present case as being blast-machined for the removal of material with the aid of abrasive agents that are blasted onto the surface being treated by means of energy carriers in a pressure or spinning process. The abrasive agent used (abrasively acting particles, for example) when pressure-blasting is transported and accelerated by liquid or gaseous energy carriers. Those processes are used especially for roughening or smoothing the surface to effect a change in strength close to the surface or to bring about deformation of the surface. It is also possible for the abrasive blasting to fulfill several functions at the same time. In an aspect, abrasive blasting processes roughen the surface. Sand-blasting is mentioned here by way of example.

“Machining” of a surface likewise can involve treating the contours of a surface of the catalyst support body. In abrasive blasting, an abrasive medium or an abrasive agent is “freely” brought into contact with a surface by means of liquid or gaseous energy carriers, whereas, in a “machining” process, a medium having fixed cutting edges is used. This applies, for example, to certain abrasives in which an abrasives or abrasive particles are firmly anchored to a reference surface (abrasive paper, grindstones, and/or milling cutters). A use of such a method, on the one hand, allows the removal of impurities on the surface of the catalyst support body that impede bonding between a coating and a catalyst support body, and again also enables the contours, that is to say the surface finish, of the surface to be influenced in the desired way. In addition, a coating can be bonded more strongly to the surface by adhesion-promoting structures located between a surface and a coating. Such structures include rod-shapes and may have barbs that engage in the coating and are bonded to the surface. Such structures can be worked out of the surface or formed as an intermediate layer from a different material having better adhesion to the surface than the coating. A further possible way of enhancing adhesiveness is a galvanic treatment of a surface that, depending upon the currents applied, can result in a roughening of a surface or in the above-mentioned rod-shaped structures.

“Cleaning” of a surface can mean any process that is able to remove, for example, oil, solvent, dirt, oxides, or similar impurities adhering to the surface. Washing or etching processes are mentioned here by way of example.

Furthermore, it is also possible for a surface to undergo thermal treatment. It is thus possible to bring about structural changes in a material of a catalyst support body that have a positive effect on the bonding of the coating. At the same time, it is also possible in this way to keep away troublesome moisture or to carry out a calcining operation.

In principle, any combination of the individual “adhesion-enhancing” methods is possible, at least the following combinations having already proven advantageous (the methods are indicated here only by the respective letters): a)+c); a)+c)+d); a)+d); b)+c); b)+c)+d); and/or c)+d).

In accordance with an embodiment of the present invention concerning a process, it is proposed that an application of the solid/fluid phase be effected at least in accordance with one of the following steps: spray-application, spreading, pouring, and/or immersion.

In an aspect, at least one of the steps is repeated at least once. In “spray-application,” the solid/fluid phase can be applied by means of a nozzle the in one aspect effects finely dispersed uniform distribution of the solid/fluid phase on a surface of a catalyst support body. In “spreading,” the solid/fluid phase can be poured onto a surface and then distributed using a suitable tool, but it is also possible for a solid/fluid phase to be applied directly to a distributing device and to make contact with a surface of the catalyst support body in that way. In “pouring,” a solid/fluid phase simply can be poured onto a surface, a uniform distribution of the solid/fluid phase then being effected, if desirable, by suitable movement of a catalyst support body. Finally, it is also possible for a solid/fluid phase to be held ready in a reservoir, for example, and a surface of a catalyst support body to be immersed therein. Such immersion can be effected with a catalyst support body at a temperature of more than about 50° C., there thus being formed a crust of uniform thickness. A further possible method of applying the catalyst coating can be screen printing. It is thereby possible for the fissure formation to be predetermined in respect of its spatial configuration by means of the structure of the screen and the mesh.

In principle, it can be advantageous for a catalyst support body to be at a temperature other than room temperature during an application, in one aspect in a range of from about 40° C. to about 800° C., in another aspect in a range of from about 40° C. to about 500° C., and in yet another aspect in a range of from about 40° C. to about 250° C. Furthermore, it can be advantageous for a catalyst support body to be moved relative to a source of a solid/fluid phase during application, so that the solid/fluid phase becomes uniformly distributed on the surface.

In accordance with an embodiment of the present invention concerning a process, a catalyst support body can be dried after application of a solid/fluid phase. This takes place in an aspect at temperatures of from about 20° C. to about 200° C., with the drying operation extending over a period of from about 0.5 hour to about 168 hours. The drying of the catalyst support body can be effected in an oxidizing atmosphere or an inert atmosphere, optionally in vacuo. It is thus possible, for example, for a coating to dry slightly each time before the next application step begins. In that way, particularly high layer thicknesses can be achieved. In addition, there can be a relatively uniform layer thickness over the entire surface.

In accordance with another embodiment concerning a process according to the present invention, a coating is formed by calcining. In one aspect, calcining can be effected at temperatures in a range of from about 200° C. to about 1000° C., in another aspect in a range of from about 210° C. to about 600° C., and in yet another aspect in a range of from about 350° C. to about 550° C., for a period of from about 0.5 hour to about 24 hours in one aspect, in another aspect a period of from about 1 hour to about 10 hours, and in yet another aspect a period of from about 1.1 hours to about 5 hours. A calcining operation can be optionally carried out in an oxidizing atmosphere or an inert atmosphere. In order to achieve, for example, a desired total fissure length, it can be advantageous to vary the temperature during a calcining operation, especially with a relatively high rate of temperature change. Those portions of the temperature sequence having a high rate of change can be optionally followed by aging periods in which the temperature is maintained level. In one aspect, there is finally a cooling step with a relatively high rate of cooling in order, in this case too, to promote the formation of fissures in the coating.

In principle, it is also possible to carry out application and calcining operations a number of times. The applied coating, or the applied coating that has already been subjected to thermal treatment, may be treated (again) optionally with at least one “adhesion-enhancing” step, the coating in one aspect then having a surface with an average surface roughness of less than about 0.2 mm.

In accordance with an embodiment of the present invention concerning a process, an applied coating can be brought into contact with at least one further solid/fluid phase for impregnation of catalytically active materials.

It is also proposed that an impregnated coating be subjected to a thermal treatment, it being advantageous for the impregnated coating to be calcined at temperatures of from about 200° C. to about 1000° C. for a period of from about 1 hour to about 24 hours.

In accordance with a further embodiment concerning a process according to the present invention, it is proposed that an applied coating can be reduced. This can be effected in a reducing atmosphere, in one aspect at temperatures in the range of from about 50° C. to about 650° C. for a period of from about 0.5 hour to about 24 hours.

Also an embodiment of the present invention concerning a process, a catalyst support body can be at least partially elastically deformed, so that fissures can be formed in a coating. “Elastic” deformation is to be understood as meaning that it does not result in permanent deformation of a catalyst support body. This relates, for example, to bending stresses, the material of the catalyst support body not being stressed beyond its limit of elasticity. In some cases, however, it may also be advisable for subsequent customization of the catalyst support body, including the coating, to be effected. It is also possible for the catalyst support body to be at least partially deformed “plastically,” that is to say to acquire a permanent new form. The deformation (elastic and/or plastic) has in turn a result that stresses, especially tensile stresses, can develop in a catalyst support body and a coating, which promote fissure formation in respect of the coating.

As a further embodiment of the present invention, there can be a process for a preparation of an organic molecule containing at least one double bond and oxygen, in which process an organic molecule containing at least one double bond is brought into contact with oxygen in the presence of a catalyst support body according to embodiments of the present invention. Molecules having double bonds include especially α-olefins. Of those, propylene is an aspect.

It is also an embodiment of the present invention that for the preparation of an organic molecule containing at least about one double bond and oxygen, an organic molecule containing at least about one double bond is brought into contact with oxygen in at least one reactor of the kind described above.

Also another embodiment of the present invention is a process for a production of a water-absorbing polymer wherein an acrylic acid, obtainable from the process according to embodiments of the present invention in the form of an organic molecule containing at least about one double bond, is polymerized.

With a view to a process for the production of a water-absorbing hygiene article, it is an embodiment that a water-absorbing polymer, in one aspect a superabsorbent polymer that has been prepared in accordance with embodiments of the presenting invention cornering above process, is incorporated into at least about one hygiene article constituent. Such a hygiene article constituent is especially a core of a diaper or sanitary napkin. Superabsorbent polymers are water-insoluble, cross-linked polymers that are able to absorb large amounts of water, aqueous fluids, especially body fluids, in aspects urine or blood, with swelling and the formation of hydrogels, and to retain such fluids under pressure. Superabsorbent polymers absorb at least about 100 times their own weight in water. Further details relating to superabsorbent polymers are disclosed in “Modern Superabsorbent Polymer Technology,” F. L. Buchholz, A. T. Graham, Wiley-VCH, 1998. By virtue of those characteristic properties, such water-absorbing polymers are incorporated chiefly into sanitary articles, such as, for example, baby's diapers, incontinence products or sanitary napkins.

Also embodiments include fibers, molded articles, films, foams, superabsorbent polymers, detergents, special polymers for the fields of wastewater treatment, disperse dyes, cosmetics, textiles, leather finishing, or paper manufacture, and hygiene articles, which are at least based on, or contain, an organic molecule containing at least about one double bond and oxygen, in an aspect (meth)acrylic acid, which are obtainable in accordance with the above-mentioned process according to embodiments of the present invention.

Finally, there is also embodiments concerning a use of an organic molecule containing at least about one double bond and oxygen, in one aspect (meth)acrylic acid, especially acrylic acid, obtainable in accordance with a process according to embodiments of the present invention concerning a preparation of an organic molecule containing at least about one double bond and oxygen, in or for the production of fibers, molded articles, films, foams, super-absorbing polymers or hygiene articles, detergents or special polymers for the fields of wastewater treatment, disperse dyes, cosmetics, textiles, leather finishing, or paper manufacture.

Some embodiments of the present invention are described in greater detail below with reference to the Figures. The Figures are exemplary embodiments, but the present invention is not limited thereto.

FIG. 1 shows a first exemplary embodiment of a catalyst support body;

FIG. 2 shows a further embodiment of a catalyst support body;

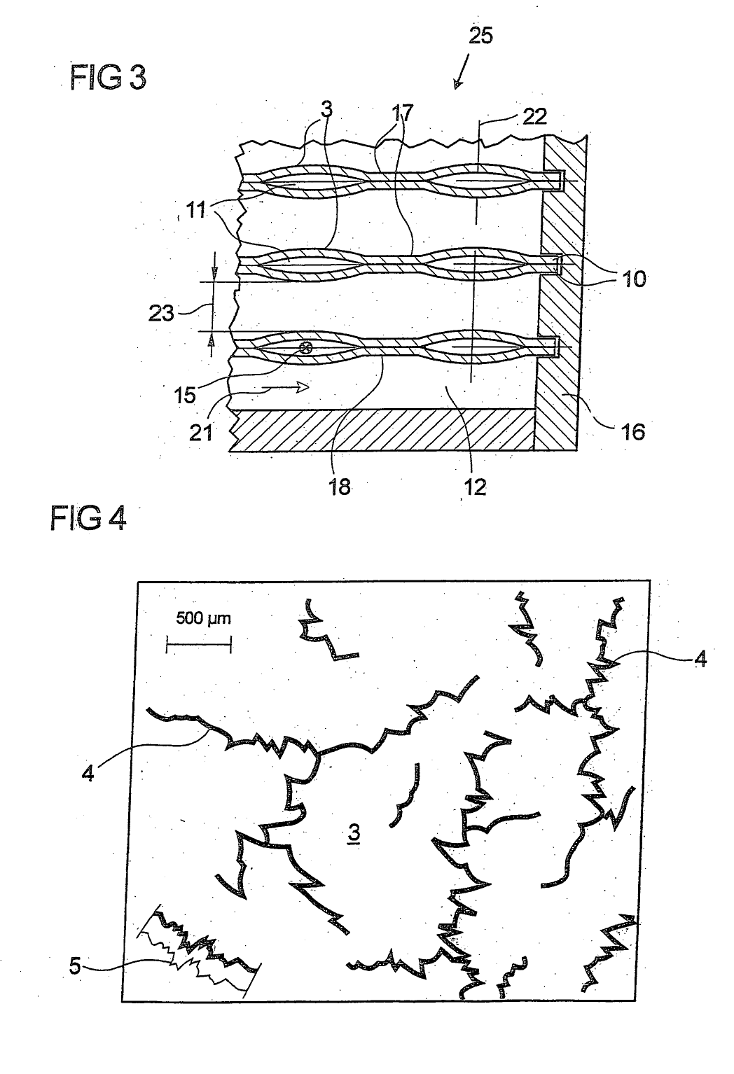

FIG. 3 is a schematic view of a structure of a reactor comprising a plurality of catalyst support bodies;

FIG. 4 is a schematic view of a coated surface having fissures, as in a further exemplary embodiment of the catalyst support body;

FIG. 5 is a schematic view of a coated surface of a catalyst support body in accordance with a further embodiment; and

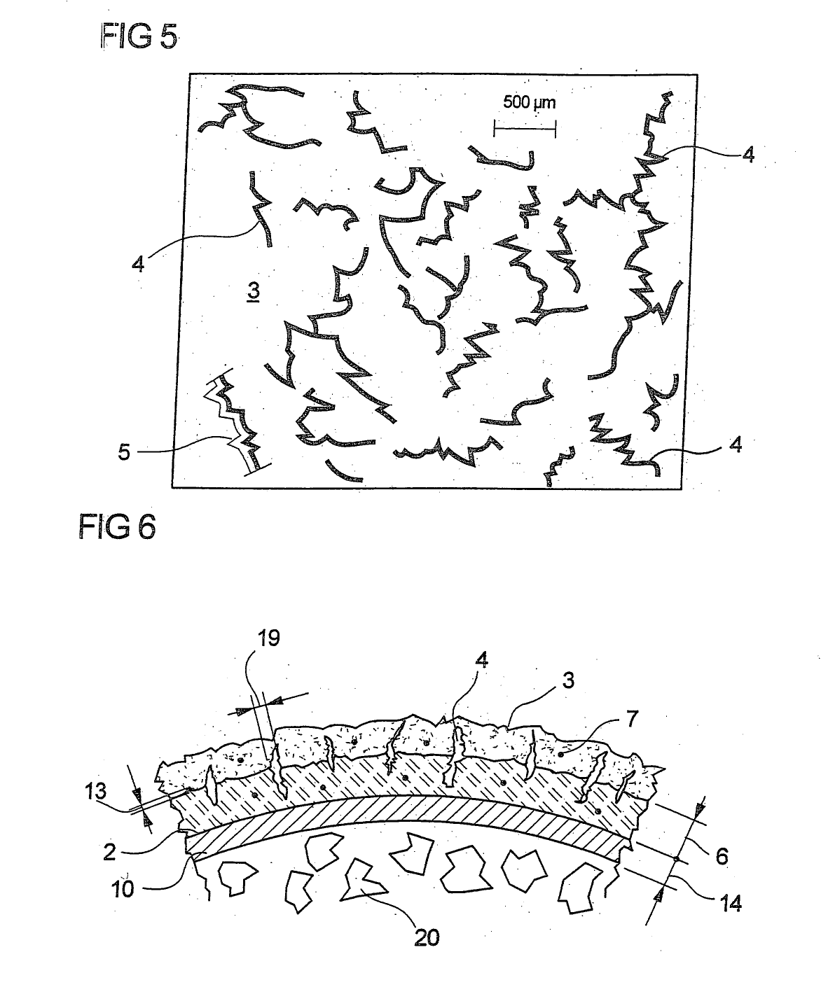

FIG. 6 is a schematic view of a detail of a further embodiment of the catalyst support body.

FIG. 1 is a diagrammatic, perspective view of a catalyst support body 1 that is in the form of a multi-walled sheet structure 8. A coating 3 has been applied to the surface 2 of the catalyst support body 1, which coating 3 has a plurality of fissures 4. The sheet structure 8 comprises two sheets that are joined to one another in predetermined connecting regions 18. As a result, between the connecting regions 18, there is formed at least one channel 9, in one aspect a plurality of channels 9, arranged substantially parallel to one another. While the surface 2 and the coating 3 are in contact with the reaction media (especially oxygen and an organic molecule containing at least about one double bond), the channels 9 serve for guiding a stream of coolant 15 that establishes a desired temperature level in respect of the catalytically motivated reaction. In the variant shown, a regular structure has been chosen for the sheet structure 8, the neighboring channels 9, which have no transverse connection with one another, being spaced equal distances 24 apart from one another. This is not absolutely essential, however.

FIG. 2 shows a diagrammatic view of a detail of a further exemplary embodiment of a catalyst support body 1 according to the present invention. The catalyst support body 1 comprises a plurality of plates 10, which form openings 11 through which a fluid is able to flow. While the catalyst support body 1 according to FIG. 1 comprises channels 9 that are separate from one another, here a plurality of interconnected cavities is provided that allow intermixing of the stream of coolant 15 running between the plates 10. The plates 10 are joined to one another in specific, here point-form, connecting regions 18, forming pillow-shaped cavities or openings 10, so that a so-called “dimpled plate” is formed (as also shown in FIG. 1). The catalyst support body 1, which here is in the form of a dimpled plate 17, facilitates uniform flow of the stream of coolant 15 in the interior of the dimpled plate 17, as shown by the dotted arrows. The coating 3 is provided on the surface 2 of the catalyst support body 1, the stream of gas 21 comprising the reactants being conveyed over the coating 3 in a direction as far as possible transverse to the stream of coolant 15 (principle: “cross-flow” and/or “counter-flow heat exchanger”). It is thus possible to achieve an especially uniform temperature level over the entire surface 2.

FIG. 3 is a diagrammatic view of a detail of a reactor 25 having a reaction chamber 12 which is bounded by a wall 16. The wall 16 fixes a plurality of dimpled plates 17 which are arranged regularly spaced 23 apart from one another. The dimpled plates 17 in turn form openings 11 through which the stream of coolant 15 is able to flow (as indicated). The stream of gas 21, which comprises the oxygen and an organic molecule containing at least one double bond, is conducted over the coating 3 of the dimpled plates 17 as far as possible traverse thereto, thus promoting an exothermic reaction. In the exemplary embodiment shown, the connecting regions 18 of the dimpled plates 17 are so arranged that the cushion-shaped openings 11 lie substantially in a plane 22. It is also possible, however, for the openings 11 or the connecting regions 18 to be so arranged that the openings 11 of neighboring dimpled plates 17 are positioned offset with respect to one another, for example in order to achieve a constant spacing 23 over the entire surface 2. The spacings range in one aspect from about 50 μm to about 1.5 mm, in another aspect from about 500 μm to about 5 mm, and in yet another aspect from about 750 μm to about 2 mm.

FIG. 4 shows, in diagrammatic form, a photograph of a coating 3 having fissures 4 produced in Example 2. The fissures 4 each have a length 5. To determine the total fissure length, the individual lengths 5 of the fissures 4 in such a photograph are added up, the absolute total fissure length obtained therefrom being related to the reference surface area of about one square meter. In the diagrammatic form of the photograph shown in FIG. 4, the fissures are relatively long and in some instances are joined together.

A slurry was applied to a catalyst support body corresponding substantially to the structure of FIG. 2.

In this case, the surface area under observation was about 32 mm². In that portion of the image, the fissures were measured by tracing the fissures and adding up the fissure lengths. Adding up the fissure lengths in that portion of the image gave an absolute total fissure length of about 27,512 μm. When related to a unit surface area of about 1 m², that corresponds to a (relative) total fissure length of about

$$848 \frac{1}{m} .$$

FIG. 5 likewise shows, in diagrammatic form, a photograph of a further coating 3 in accordance with Example 3 having fissures 4. The fissures 4 shown are noticeably shorter, but in this case the number of fissures 4 is significantly higher than in FIG. 4.

The diagrammatic form of the photograph in FIG. 5 shows a portion of a coating 3.

A slightly different magnification was selected for the photograph shown in FIG. 5 because the fissures 4 in this case are of shorter length 5. The two scales used in FIGS. 4 and 5 can be compared by way of the reference length of about 500 μm. The measured surface area in FIG. 5 is about 9 mm². The absolute total fissure length obtained was a value of about 24,596 μm. That is to say, in other words, that the (relative) total fissure length is about

$$2 , 515 \frac{1}{m} .$$

FIG. 6 is a diagrammatic view of a detail of a variant of a catalyst support body 1, which shows a portion of a plate 10, the surface 2 of which is provided with a coating 3. The coating 3 has a plurality of fissures 4 that have a width 19 and extend over at least about 80% of the layer height 6. The coating 3 comprises, in addition, various constituents 7 which, inter alia, promote a catalytic reaction between an organic molecule containing at least about one double bond and oxygen. The plate 10 here has a sheet thickness 14 in the region of from about 100 μm to about 50 mm.

On the side of the plate 10 remote from the coating 3, there is arranged a coolant 20 that may flow along the inner side of the plate 10 and accordingly ensure uniform dissipation of the heat generated by the catalytic reaction.

The present invention is described in greater detail with reference to following non-limiting Examples:

### EXAMPLES

1. Preparation of the Crude Catalyst Powder.

In accordance with DE-OS 16 18 744, as precursor 424 g of ammonium paramolybdate, 47 g of ammonium metavanadate and 27 g of ammonium paratungstate were dissolved separately in distilled water, the resulting solutions were mixed and 236 g of silica sol were added to the mixture. The resulting slurry was dried, and the solid cake was pulverized by grinding in a ball mill in order to obtain the crude catalyst powder.

2. Comparison Example of a Coating (FIG. 4)

100 g of crude catalyst powder and 5 g of AEROSIL® (Degussa AG, Germany) were mixed together and homogenized with 120 g of totally deionized water, with stirring, and then poured onto the face to be coated on a steel sheet (1.457 according to DIN EN 10 027; sheet thickness 0.5 mm, surface area 50×300 mm). The face was surrounded by lateral boundaries having a height of 1 mm measured from the surface of the face, so that the height of the boundary determines the maximum coating thickness. The face was degreased prior to coating and then sand-blasted. Coating dispersion projecting above the lateral boundaries was removed in order to obtain a uniform layer thickness of 1 mm. After drying at room temperature, calcining was carried out. For this purpose, heating was carried out at a rate of 120 K/min to 550° C., then at a rate of 2 K/min to 570° C. That temperature was maintained for 30 minutes, and then cooling was carried out at a cooling rate of 5 K/min for 10 minutes and then at an exponentially decelerating cooling rate to room temperature. The adhesion was less than 10 N/m².

3. Coating According to the Present Invention (FIG. 4)

For this purpose, the above Example was followed, with 0.5 g of Tylose® (cellulose ether) being additionally used for the preparation of the coating suspension. The adhesion was 500 N/m².

1. A catalyst support comprising a body having a surface and a coating bonded to the surface, is wherein the coating comprises fissures having a a total fissure length of at least about 500 m/m² [meters per square meter] and the coating comprises an adhesive tensile strength of at least about 500 N/m² [Newtons per square meter].

2. The catalyst support according to claim 1, wherein the coating comprises a layer thickness of at least about 0.02 mm [millimeters].

3. The catalyst support according to claim 1, wherein the total fissure length comprises at least about 1000 m/m² [meters per square meter].

4. The catalyst support according to claim 1, wherein the body comprises a first thermal expansion coefficient and the coating comprises a second thermal expansion coefficient, the two thermal expansion coefficients differing, at least at a temperature in the range of from about 20° C. to about 65° C., by at least about 10%.

5. The catalyst support according to claim 1, wherein the coating comprises a catalytically active coating for a partial oxidation of propene and acrolein.

6. The catalyst support according to claim 1, wherein the coating comprises at least one inert constituent.

7. The catalyst support according to claim 1, wherein the coating comprises at least one constituent containing silicon or aluminum and oxygen.

8. The catalyst support according to claim 4, wherein the body is constructed using metallic material.

9. The catalyst support according to claim 1, wherein the body comprises a multi-walled sheet structure with at least one channel through which a fluid is able to flow.

10. The catalyst support according to claim 8, wherein the body comprises a plurality of plates and the latter form openings through which a fluid is able to flow.

11. The catalyst support according to claim 1, wherein the body is constructed using ceramic material.

12. A reactor for the preparation of polymerizable monomers having at least one reaction chamber through which a fluid is able to flow, the at least one reaction chamber comprising at least one catalyst support in accordance with claim 1.

13. A process for the production of a coating on a surface of a support body, the process comprising the steps:
subjecting the support body to adhesion-enhancing treatment:
preparing a solid/fluid phase comprising a catalyst capable of forming an organic molecule containing at least one double bond and oxygen;
applying of the solid/fluid phase to the support body; and
forming a coating having fissures having a total fissure length comprising at least about 500 m/m² [meters per square meter].

14. The process according to claim 13, wherein the subjecting of the support body to adhesion-enhancing treatment is prior to the applying of the solid/fluid phase.

15. The process according to claim 14, wherein at least one of the following steps is carried out with respect to the support body:
a) abrasive blasting a surface;
b) machining a surface;
c) cleaning a surface; or
d) thermally treating a surface.

16. The process according to claim 13, wherein the applying of the solid/fluid phase comprises at least one of spraying, spreading, pouring, or immersing.

17. The process according to claim 13, further comprising drying the support body after the application of the solid/fluid phase.

18. The process according to claim 13, wherein the forming of the coating comprises calcining.

19. The process according to claim 13, further comprising contacting the coating with at least one additional solid/fluid phase comprising at least one catalytically active material.

20. The process according to claim 19, further comprising thermally treating the coating contacted with the at least one additional solid/fluid phase comprising at least one catalytically active material.

21. The process according to claim 13, further comprising reducing the coating.

22. The process according to claim 13, further comprising at least partially elastically deforming the support body, so that fissures are formed in the coating.

23. A process for the preparation of an organic molecule containing at least one double bond and oxygen, the process comprising contacting an organic molecule containing at least one double bond with oxygen in the presence of a catalyst support according to claim 1.

24. A process for the preparation of an organic molecule containing at least one double bond and oxygen, the process comprising contacting an organic molecule containing at least one double bond with oxygen in at least one reactor according to claim 12.
